(19) United States
(12) Patent Application Publication
(10) Pub. No.: US 2026/0088018 A1
(43) Pub. Date: Mar. 26, 2026

(54) WAKE-UP WORD DETECTION METHOD, ELECTRONIC DEVICE, AND STORAGE MEDIUM

(71) Applicant: Beijing Zitiao Network Technology Co., Ltd., Beijing (CN)

(72) Inventors: Wenzhi FAN, Beijing (CN); Yangfei XU, Beijing (CN)

(21) Appl. No.: 19/296,217

(22) Filed: Aug. 11, 2025

(30) Foreign Application Priority Data
Sep. 26, 2024 (CN) 202411355254.5

(51) Int. Cl. G10L 15/06; G10L 15/02; G10L 15/04; G10L 15/22

(52) U.S. Cl. CPC G10L 15/063; G10L 15/02; G10L 15/04; G10L 15/22; G10L 2015/223

(57) ABSTRACT

Embodiments of the present disclosure relate a wake-up word detection method and apparatus, an electronic device, and a storage medium, and the method includes: acquiring audio data and at least one wake-up word; inputting the audio data and the at least one wake-up word into a wake-up word detection model to output a frame-level detection probability of the audio data for the at least one wake-up word, wherein the wake-up word detection model is determined through stage-wise training using a positive and negative sample dataset constructed based on the at least one wake-up word; and determining, based on the frame-level detection probability, a wake-up word detection result of the audio data for the at least one wake-up word.

### CROSS-REFERENCE TO RELATED APPLICATION

The present application claims the priority to Chinese Patent Application No. 202411355254.5, filed on Sep. 26, 2024, the entire disclosure of which is incorporated herein by reference as portion of the present application.

### TECHNICAL FIELD

Embodiments of the present disclosure relate to a wake-up word detection method and apparatus, an electronic device, and a storage medium.

### BACKGROUND

With the popularity of smart devices, human-computer interactions with the smart devices through speech instructions have become especially important. A user can wake up a smart device with a wake-up word in the speech interaction process, and therefore, the wake-up word detection for the smart device is of great significance for the humane-machine interaction experience. For the detection for a custom wake-up word in the related art, a large volume of audio data needs to be collected, and then postprocessed and calibrated to achieve the expected effect, resulting in defects of high cost, long time consumed, high difficulty, and low wake-up rate.

### SUMMARY

To solve the above-mentioned technical problems, the present disclosure provides a wake-up word detection method and apparatus, an electronic device, and a storage medium.

The embodiments of the present disclosure provide a wake-up word detection method, and the method includes:
acquiring audio data and at least one wake-up word;
inputting the audio data and the at least one wake-up word into a wake-up word detection model to output a frame-level detection probability of the audio data for the at least one wake-up word, where the wake-up word detection model is determined through stage-wise training using a positive and negative sample dataset constructed based on the at least one wake-up word;
and determining, based on the frame-level detection probability, a wake-up word detection result of the audio data for the at least one wake-up word.

The embodiments of the present disclosure further provide a wake-up word detection apparatus, and the apparatus includes:
an acquisition module configured to acquire audio data and at least one wake-up word;
an outputting module configured to input the audio data and the at least one wake-up word into a wake-up word detection model to output a frame-level detection probability of the audio data for the at least one wake-up word, where the wake-up word detection model is determined through stage-wise training using a positive and negative sample dataset constructed based on the at least one wake-up word;
and a determination module configured to determine, based on the frame-level detection probability, a wake-up word detection result of the audio data for the at least one wake-up word.

The embodiments of the present disclosure further provide an electronic device, and the electronic device includes a processor and a memory configured to store instructions executable by the processor; and the processor is configured to read the instructions from the memory and execute the instructions to implement the wake-up word detection method provided by the embodiments of the present disclosure.

The embodiments of the present disclosure further provide a computer-readable storage medium, a computer program is stored in the storage medium, and the computer program is configured to perform the wake-up word detection method provided by the embodiments of the present disclosure.

### BRIEF DESCRIPTION OF DRAWINGS

In conjunction with the drawings and with reference to the following detailed description, the above-mentioned and other features, advantages, and aspects of the various embodiments of the present disclosure will become more apparent. Throughout the drawings, the same or similar reference numerals denote the same or similar elements. It should be understood that the drawings are illustrative and the components and elements are not necessarily drawn to scale.

FIG. 1 is a schematic flowchart of a wake-up word detection method provided by the embodiments of the present disclosure;

FIG. 2 is a schematic flowchart of another wake-up word detection method provided by the embodiments of the present disclosure;

FIG. 3 is a schematic flowchart of yet another wake-up word detection method provided by the embodiments of the present disclosure;

FIG. 4 is a schematic structural diagram of a wake-up word detection apparatus provided by the embodiments of the present disclosure; and

FIG. 5 is a schematic structural diagram of an electronic device provided by the embodiments of the present disclosure.

### DETAILED DESCRIPTION

Embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that the various steps described in the method embodiments of the present disclosure may be performed in different orders and/or in parallel. Furthermore, the method embodiments may include additional steps and/or omit performing the illustrated steps. The protection scope of the present disclosure is not limited in this aspect.

As used herein, the term “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not used to limit the interdependence relationship or the order of functions performed by these devices, modules or units.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

The names of the messages or information exchanged between a plurality of apparatuses in the embodiments of the present disclosure are for illustrative purposes only and are not intended to limit the scope of these messages or information.

As a mainstream trigger mechanism for the human-computer interaction process, the wake-up word detection has been widely applied to a plurality of fields such as consumer electronics, conference communication, and vehicular audio. Existing smart devices mostly support one or more preset wake-up words. To further meet the needs of consumers for custom wake-up words, the detection technique for custom wake-up words has become the focus of research in recent years.

An existing detection technique for custom wake-up words requires recording of audios for a plurality of times to guarantee the wake-up performance, and thus is high in cost, and the accuracy rate of the detection technique for wake-up words will be affected by ambient noise and room reverb. To solve the problems, data is typically augmented when a wake-up word detection model is trained to increase the noise robustness, and an audio is subjected to preprocessing steps such as denoising and dereverberation prior to wake-up word detection, thereby improving the quality of the wake-up audio, etc. For example, a detection technique for wake-up words based on a single microphone system is low in wake-up rate in a high noise scenario, while a system based on cascaded microphone array signal processing and single-channel wake-up detection can increase the wake-up rate in the high noise scenario to a certain extent. However, limited by problems such as matching of front-end and back-end data features, the increase of the wake-up rate is limited. In addition, the detection of text custom wake-up words, as a non-end-to-end wake-up solution, requires some decoding postprocessing steps and a calibration step for a target wake-up word scoring mechanism to achieve the expected wake-up effect. However, it is difficult to deploy this solution in an end side embedded system in real time due to high internal memory and computation overheads. To sum up, the existing detection techniques for custom wake-up words have the defects of high cost, long time consumed, high difficulty, and low wake-up rate, and there is a need for an innovative method to resolve these challenges in the detection techniques for custom wake-up words.

To solve the above-mentioned problems, the embodiments of the present disclosure provide a wake-up word detection method, which will be described below in combination with specific embodiments.

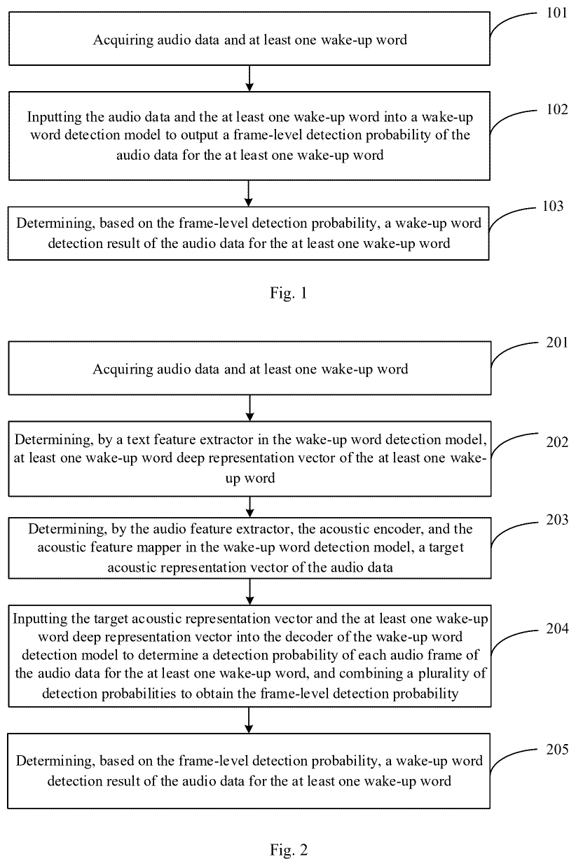

FIG. 1 is a schematic flowchart of a wake-up word detection method provided by the embodiments of the present disclosure. The method may be performed by a wake-up word detection apparatus, where the apparatus may be implemented by software and/or hardware and may be generally integrated into an electronic device. As shown in FIG. 1, the method includes the following steps.
Step 101: acquiring audio data and at least one wake-up word.

In the embodiments of the present disclosure, the audio data may be any audio data needing to be performed by wake-up word detection. The specific volume and source of the audio data are not limited. The audio data may be any audio data collected by a terminal device (e.g., a microphone). For example, a user may collect a real-time audio in the surroundings using a microphone, and a collected audio signal is used as the audio data. The wake-up word detection in the embodiments of the present disclosure may refer to detecting whether a specific wake-up word is included in an audio stream.

In the embodiments of the present disclosure, the wake-up word refers to a specific word for activating an electronic device with the speech wake-up function. Specifically, the wake-up word may be a custom word based on a user requirement, and may also be a fixed wake-up word preset by the system.
Step 102: inputting the audio data and the at least one wake-up word into a wake-up word detection model to output a frame-level detection probability of the audio data for the at least one wake-up word.

The wake-up word detection model is a model constructed in the embodiments of the present disclosure to detect whether there is a wake-up word in audio data to be detected.

The wake-up word detection model may be determined based on stage-wise training. Specifically, the stage-wise training may be achieved through training in multiple stages. For example, the process of the training in multiple stages may be construed as starting training from a single module and gradually training more modules until all the modules are trained completely. The stage-wise training method allows the trained modules to participate in training at subsequent stages, thus enhancing the overall training effect and the accuracy of the model.

The wake-up word detection model is determined through stage-wise training using a positive and negative sample dataset constructed based on at least one wake-up word.

The frame-level detection probability may be a detection probability calculated for each audio frame among a plurality of audio frames segmented from the audio data in the audio data processing process. In frame-level detection, each audio frame has a fixed time length, e.g., 10 ms.

In the embodiments of the present disclosure, the frame-level detection probability of the audio data for at least one wake-up word refers to a combination of detection probabilities for the presence of each wake-up word in each audio frame among audio frames segmented from the audio data.

Exemplarily, assuming that the respective audio frames corresponding to the audio data include a first audio frame, a second audio frame, and a third audio frame, and at least one wake-up word includes a wake-up word 1, then the frame-level detection probability of the audio data for the wake-up word 1 is a combination of the detection probability of the first audio frame for the wake-up word 1, the detection probability of the second audio frame for the wake-up word 1, and the detection probability of the third audio frame for the wake-up word 1.
Step 103: determining, based on the frame-level detection probability, a wake-up word detection result of the audio data for the at least one wake-up word.

The wake-up word detection result is used for detecting whether there is a wake-up word in the audio data, i.e., whether the wake-up word exists or does not exist. If the wake-up word detection result is “the wake-up word exists”, it indicates that the existence of the wake-up word is detected in the audio data. If the wake-up word detection result is “the wake-up word does not exist”, it indicates that the wake-up word does not exist in the audio data.

In the embodiments of the present disclosure, the wake-up word detection result of the audio data for the at least one wake-up word is used for determining whether each wake-up word exists in the respective audio frames in the audio data.

For ease of understanding, the following description is also made by taking the case that the respective audio frames corresponding to the audio data include the first audio frame, the second audio frame, and the third audio frame and the at least one wake-up word includes the wake-up word 1 as an example.

Correspondingly, the frame-level detection probability of the audio data for the wake-up word 1 is the combination of the detection probability of the first audio frame for the wake-up word 1, the detection probability of the second audio frame for the wake-up word 1, and the detection probability of the third audio frame for the wake-up word 1.

If the detection probability of the first audio frame for the wake-up word 1 meets a preset condition, the wake-up word detection result of the first audio frame for the wake-up word 1 is that the wake-up word 1 can be detected in the first audio frame.

To improve the accuracy of the wake-up word detection result, in an optional embodiment, the detection probability of each audio frame in the frame-level detection probability is compared with at least one wake-up word probability threshold corresponding to the at least one wake-up word. In response to the detection probability of a target audio frame being greater than the wake-up word probability threshold of a target wake-up word, it is determined that the target wake-up word is detected in the target audio frame in the audio data.

The target audio frame may be any audio frame in the audio data, and the target wake-up word may be any wake-up word among the at least one wake-up word.

In the embodiments of the present disclosure, the wake-up word probability threshold refers to a probability threshold for determining whether a corresponding wake-up word is detected in the respective audio frames corresponding to the output audio data.

In the embodiments of the present disclosure, during the wake-up word detection stage, the corresponding wake-up word probability threshold may be set for each wake-up word. The detection probability of each audio frame in the frame-level detection probability is compared with the wake-up word probability threshold set for each wake-up word to determine whether each wake-up word can be detected in the respective audio frames.

Exemplarily, taking the case that the target audio frame is a t-th audio frame in the audio data and the target wake-up word is an i-th wake-up word as an example, assuming that the probability threshold of the i-th wake-up word is set to val(i), if the detection probability Po(i) of the t-th audio frame in the output audio data is greater than val(i), it is determined that the i-th wake-up word is detected at the moment of the t-th audio frame in the output audio data.

In addition, to reduce false positives in the wake-up word detection results, once a wake-up word is detected, further wake-up word detection is not performed in a short time, e.g., 500 ms.

The wake-up word detection method provided by the embodiments of the present disclosure includes: acquiring audio data and at least one wake-up word; inputting the audio data and the at least one wake-up word into a wake-up word detection model to output a frame-level detection probability of the audio data for the at least one wake-up word, where the wake-up word detection model is determined through stage-wise training using a positive and negative sample dataset constructed based on the at least one wake-up word; and determining, based on the frame-level detection probability, a wake-up word detection result of the audio data for the at least one wake-up word. With the above-mentioned technical solution, the wake-up word detection model can be determined by stage-wise training using the positive and negative sample dataset constructed based on the at least one wake-up word, and the wake-up word in the audio data can be detected directly using the wake-up word detection model. The training of the wake-up word detection model may be achieved by relying on a general audio-text pair without collecting a large volume of audio data from different speakers for the wake-up word, thereby reducing the data collection cost and the implementation difficulty and improving the efficiency of model training. Moreover, by end-to-end stage-wise training and application, the wake-up rate is increased, and the steps such as postprocessing and calibration are not needed, thereby simplifying the process and effectively improving the efficiency of wake-up word detection.

FIG. 2 is a schematic flowchart of another wake-up word detection method provided by the embodiments of the present disclosure. This embodiment provides further improvements on the wake-up word detection method on the basis of the above embodiment. As shown in FIG. 2, the method includes the following steps.
Step 201: acquiring audio data and at least one wake-up word.
Step 201 is the same as the above-mentioned step 101. See the description on the above-mentioned step 101 for details.
Step 202: determining, by a text feature extractor in the wake-up word detection model, at least one wake-up word deep representation vector of the at least one wake-up word.

The wake-up word detection model includes an audio feature extractor, an acoustic encoder, an acoustic feature mapper, a text feature extractor, and a decoder. The wake-up word detection model is determined through stage-wise training using a positive and negative sample dataset constructed based on the at least one wake-up word.

In the embodiments of the present disclosure, the wake-up word detection model is obtained by performing the stage-wise training on the audio feature extractor, the acoustic encoder, the acoustic feature mapper, the text feature extractor, and the decoder using the positive and negative sample dataset constructed based on the at least one wake-up word. For the process of determining the wake-up word detection model, see the description of acquiring the wake-up word detection model by performing the stage-wise training on an initial model in the following embodiment for details.

For ease of further understanding of the audio feature extractor, the acoustic encoder, the acoustic feature mapper, the text feature extractor, and the decoder included in the wake-up word detection model, the audio feature extractor, the acoustic encoder, the acoustic feature mapper, the text feature extractor, and the decoder are described in detail in the embodiments of the present disclosure, respectively.

The audio feature extractor is configured to extract an audio feature from the audio data. For example, the audio feature of the audio data can be extracted by the audio feature extractor, where the length of the audio feature is the total number of frames, and the height is the number of extracted audio features.

The audio feature extractor may be a single-channel feature extractor, and may also be a multi-channel feature extractor.

In the audio processing field, the audio feature extractor may include, but is not limited to, a Mel-spectral coefficient extractor, a Mel-frequency cepstral coefficient extractor, etc. Exemplarily, the frame length of the audio feature extractor may be set to 25 ns, the frame shift may be set to 10 ms, and the number of the extracted audio features may be set to 80. That is, the audio feature extractor can segment the audio data into a series of windows having a duration of 25 ms, with an interval of 10 ms between adjacent windows, and extract 80 audio features from each window.

The acoustic encoder is configured to use an audio feature as an input and convert, by a neural network or other algorithms, the audio feature to an initial acoustic representation vector.

Exemplarily, the audio feature of the audio data is input into the acoustic encoder, and the network outputs an acoustic representation vector in a certain dimension per M frames. A combination of the acoustic representation vectors in the certain dimension output by the network per M frames is the initial acoustic representation vector, where M is the downsampling rate.

The text feature extractor is configured to extract a text deep representation vector from a text. For example, a wake-up word deep representation vector corresponding to a wake-up word can be extracted by the text feature extractor.

The text feature extractor includes a vocabulary feature extractor and a text encoder.

The vocabulary feature extractor is configured to determine an element of a text mapped to a text vocabulary and generate an element vector for each element, and determine a combination of respective element vectors as a text initial representation vector, where the text may be the above-mentioned wake-up word, and may also be other texts.

The element vector of each element mentioned above may be obtained by vectorizing the element by a vectorization module which may be fixed in dimensions through training.

In the embodiments of the present disclosure, when the text is in Chinese, the text vocabulary may be a Pinyin vocabulary or an Initial-Final vocabulary, etc.

Exemplarily, when the text is Chinese characters of “ [symbol] ”, the elements of the corresponding wake-up word mapped to the text vocabulary are x, i, a, o, g, u, a, n, j, i, and a.

In the embodiments of the present disclosure, when the text is in English, the text vocabulary may be a vocabulary corresponding to English, and its specific implementation is similar to that when the wake-up word is in Chinese, which will not be described redundantly in the embodiments of the present disclosure.

The text encoder is configured to use the above-mentioned text initial representation vector as the input and convert, by encoding, the text initial representation vector to a text deep representation vector.

Exemplarily, the text encoder can perform masking on an input wake-up word initial representation vector to obtain a corresponding wake-up word deep representation vector.

The acoustic feature mapper is configured to align an acoustic vector corresponding to the audio data with a text vector corresponding to the audio data in a feature space of vectors such that the acoustic vector and the text vector are consistent in terms of dimension.

In the embodiments of the present disclosure, with the initial acoustic representation vector and the text deep representation vector as inputs, the feature space of the initial acoustic representation vector is aligned with the feature space of the deep text representation vector so that a target acoustic representation vector can be obtained.

The decoder may be a module configured to determine a detection probability of each audio frame in the audio data for a particular text in the embodiments of the present disclosure, where the particular text may be a wake-up word.

In the embodiments of the present disclosure, the above-mentioned target acoustic representation vector and wake-up word deep representation vector may be used as inputs, and the output is the detection probability of each audio frame in the audio data for the wake-up word.

In the embodiments of the present disclosure, at least one wake-up word is used as the input into the text feature extractor, and after the input is processed by the text feature extractor, wake-up word deep representation vectors respectively corresponding to the respective wake-up words are output.

Exemplarily, taking the case that the at least one wake-up word includes the wake-up word 1 as an example, the wake-up word 1 is used as the input into the text feature extractor, and after the input is processed by the text feature extractor, the wake-up word deep representation vector corresponding to the wake-up word 1 is output.

In an optional embodiment, the text feature extractor includes a vocabulary feature extractor and a text encoder. For example, at least one element of each wake-up word mapped to the text vocabulary can be determined by the vocabulary feature extractor, and a combination of at least one element vector of the at least one element is determined as a wake-up word initial representation vector. The wake-up word initial representation vector of each wake-up word is encoded by the text encoder to determine the corresponding wake-up word deep representation vector.

For the specific description of the vocabulary feature extractor and the text encoder, reference may be made to the above description.

In the embodiments of the present disclosure, the vocabulary feature extractor may be implemented by constructing a text vocabulary and a corresponding mapping rule. For example, the vocabulary feature extractor is configured to map each wake-up word to at least one element in the text vocabulary, generate an element vector for each element, and determine a combination of respective element vectors as the wake-up word initial representation vector.

In the embodiments of the present disclosure, after the respective elements of each wake-up word mapped to the text vocabulary are determined by the vocabulary feature extractor, the respective elements are mapped to the element vectors of the corresponding elements, respectively, to obtain element vectors respectively corresponding to the elements, and a combination of element vectors respectively corresponding to the respective elements is determined as the wake-up word initial representation vector. The length of the wake-up word initial representation vector is the number of elements of the wake-up word mapped to the text vocabulary.

Exemplarily, taking the wake-up word 1 as an example, and assuming that the elements of the wake-up word 1 mapped to the text vocabulary include an element 1 and an element 2. For example, after the element 1 and the element 2 of the wake-up word 1 mapped to the text vocabulary are determined by the vocabulary feature extractor, the element 1 and the element 2 are mapped to the corresponding element vectors, respectively, to obtain an element vector 1 and an element vector 2 respectively corresponding to the element 1 and the element 2, and a combination of the element vector 1 and the element vector 2 is determined as the wake-up word initial representation vector of the wake-up word 1. Then, with the initial representation vector of the wake-up word 1 as an input to the text encoder, the initial representation vector of the wake-up word 1 is encoded by the text encoder to obtain the wake-up word deep representation vector corresponding to the wake-up word 1.

It should be noted that for the detailed process of the stage-wise training of the wake-up word detection model, reference is made to the description of the following embodiments, which will not be repeated in the embodiments of the present disclosure.
Step 203: determining, by the audio feature extractor, the acoustic encoder, and the acoustic feature mapper in the wake-up word detection model, a target acoustic representation vector of the audio data.

For the specific description of the audio feature extractor, the acoustic encoder, and the acoustic feature mapper, reference is made to the above description.

In an optional embodiment, an audio feature of the audio data is extracted by the audio feature extractor, and the audio feature is input into the acoustic encoder to determine an initial acoustic representation vector, and the feature space of the initial acoustic representation vector is aligned with the feature space of the wake-up word deep representation vector by the acoustic feature mapper to obtain a target acoustic representation vector.

In the embodiments of the present disclosure, the audio data is used as an input into the audio feature extractor and processed by the audio feature extractor to obtain the audio feature of the audio data. The audio feature is then used as an input into the acoustic encoder and processed by the acoustic encoder to obtain an initial acoustic representation vector. Then, the initial acoustic representation vector and the above obtained wake-up word deep representation vector are used as inputs and processed by the acoustic feature mapper, and the feature space of the initial acoustic representation vector is aligned with the feature space of the wake-up word deep representation vector (aligned in vector dimension) to obtain the target acoustic representation vector.
Step 204: inputting the target acoustic representation vector and the at least one wake-up word deep representation vector into the decoder of the wake-up word detection model to determine a detection probability of each audio frame of the audio data for the at least one wake-up word, and combining a plurality of detection probabilities to obtain the frame-level detection probability.

For the description of the decoder, reference is made to the above description.

In the embodiments of the present disclosure, the target acoustic representation vector and the at least one wake-up word deep representation vector are used as inputs into the decoder of the wake-up word detection model and processed by the decoder to output detection probabilities of the respective audio frames of the audio data for each wake-up word. A plurality of detection probabilities obtained are then combined to obtain the frame-level detection probability.

In an optional embodiment, the target acoustic representation vector is segmented by audio frame to obtain acoustic representation vectors of a plurality of audio frames; and the acoustic representation vectors of the audio frames and each wake-up word deep representation vector are input into the decoder to obtain the detection probability of each audio frame for each wake-up word.

In the embodiments of the present disclosure, by audio frame-level, the target acoustic representation vector is segmented into acoustic representation vectors of a plurality of audio frames. That is, the target acoustic representation vector is split into a set composed of the acoustic representation vectors of the plurality of audio frames, and then audio frame acoustic representation vector-wake-up word deep representation vector pairs are constructed with the acoustic representation vectors of the audio frames and each wake-up word deep representation vector. the respective audio frame acoustic representation vector-wake-up word deep representation vector pairs are input into the decoder to obtain the detection probabilities of each audio frame for the respective wake-up words.
Step 205: determining, based on the frame-level detection probability, a wake-up word detection result of the audio data for the at least one wake-up word.
Step 205 is the same as the above-mentioned step 103. See the description on the above-mentioned step 103 for details.

The wake-up word detection method provided by the embodiments of the present disclosure includes: acquiring audio data and at least one wake-up word; determining, by the text feature extractor in the wake-up word detection model, at least one wake-up word deep representation vector of the at least one wake-up word; determining, by the audio feature extractor, the acoustic encoder, and the acoustic feature mapper in the wake-up word detection model, a target acoustic representation vector of the audio data; inputting the target acoustic representation vector and the at least one wake-up word deep representation vector into the decoder of the wake-up word detection model to determine a detection probability of each audio frame of the audio data for the at least one wake-up word, and combining a plurality of detection probabilities to obtain the frame-level detection probability, where the wake-up word detection model is determined through stage-wise training using a positive and negative sample dataset constructed based on the at least one wake-up word; and determining, based on the frame-level detection probability, a wake-up word detection result of the audio data for the at least one wake-up word. With the above technical solution, the wake-up word detection model can be determined through stage-wise training using the positive and negative sample dataset constructed based on the at least one wake-up word, and the at least one wake-up word in the audio data can be detected directly using the wake-up word detection model. The training of the wake-up word detection model can be achieved by relying on general audio-text pairs without collecting a large volume of audio data from different speakers for the at least one wake-up word, thereby reducing the data collection cost and the implementation difficulty and improving the efficiency of model training. Moreover, by end-to-end stage-wise training and application, the wake-up rate is increased, and the steps such as postprocessing and calibration are not needed, thereby simplifying the process and effectively improving the efficiency of wake-up word detection.

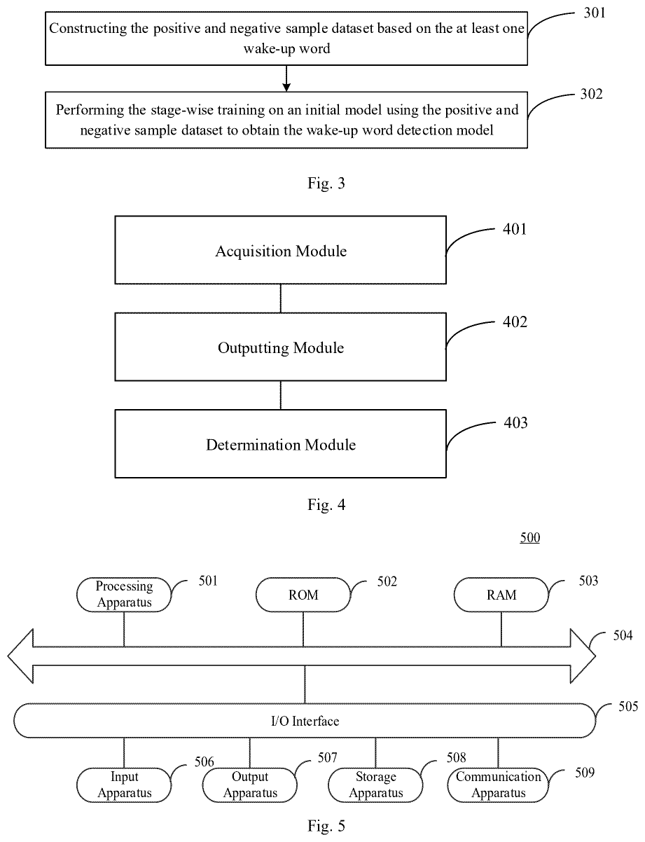

FIG. 3 is a schematic flowchart of yet another wake-up word detection method provided by the embodiments of the present disclosure. As shown in FIG. 3, in a feasible embodiment, the wake-up word detection method in the embodiments of the present disclosure may further include the following steps.
Step 301: constructing the positive and negative sample dataset based on the at least one wake-up word.

In the embodiments of the present disclosure, the positive and negative sample dataset is configured to perform the stage-wise training on an initial model to obtain a wake-up word detection model, so that the wake-up word detection model can accurately recognize a wake-up word.

A positive sample refers to a sample containing a target feature. In a wake-up word recognition scenario, the positive sample may be audio data containing wake-up words. For example, the positive sample dataset may be acquired from an audio clip containing a wake-up word in existing audio data, and may also be acquired based on an audio clip containing a wake-up word provided by a user.

A negative sample refers to a sample containing no target feature. In the wake-up word recognition scenario, the negative sample may be audio data containing no wake-up word. For example, a negative sample dataset may be acquired from an audio clip containing no wake-up word in the same dataset as the positive sample dataset, and may also be acquired from an audio clip containing no wake-up word in other datasets.

In an optional embodiment, the positive and negative sample dataset includes a plurality of positive samples and a plurality of negative samples; each positive sample includes audio data with one wake-up word and text data thereof; and each negative sample includes audio data without the at least one wake-up word and text data thereof.

In the embodiments of the present disclosure, to improve the detection precision of the wake-up word detection model, the positive samples and the negative samples are constructed in a certain ratio. For example, it may be set that the number of the positive samples included in the positive and negative sample dataset is greater than the number of the negative samples included in the positive and negative sample dataset.

In the embodiments of the present disclosure, the positive sample includes audio data with one wake-up word, and text data corresponding to the audio data. Furthermore, the positive sample may further include text data corresponding to a wake-up word, and timestamp data corresponding to the wake-up word in the audio data.

In the embodiments of the present disclosure, the negative sample includes audio data without a wake-up word and corresponding text data thereof. That is, in the negative samples, the audio data in the negative samples includes no wake-up word.
Step 302: performing the stage-wise training on an initial model using the positive and negative sample dataset to obtain the wake-up word detection model.

In the embodiments of the present disclosure, after the positive and negative sample dataset is constructed based on the at least one wake-up word, the stage-wise training may be performed on the text feature extractor, the acoustic encoder, the acoustic feature mapper, and the decoder in the initial model using the positive and negative sample dataset to obtain the wake-up word detection model.

In an optional embodiment, step 302 may be implemented through step 302-1 to step 302-4.
Step 302-1: inputting audio data of respective samples in the positive and negative sample dataset into an audio feature extractor in the initial model to obtain audio features of the respective samples, and firstly training an acoustic encoder in the initial model using the audio features and text data of the respective samples.

In the embodiments of the present disclosure, the audio feature extractor in the initial model may be a trained audio feature extractor. For example, the audio feature extractor may be obtained through training using the audio data of the respective samples and the audio features of the respective samples.

In the embodiments of the present disclosure, after the audio features of the respective samples are obtained, the audio features of the respective samples are used as inputs into the acoustic encoder in the initial model, and the acoustic encoder is trained using a speech recognition related cost function. Specific steps are as follows.
1. The network structure of the acoustic encoder in the initial model may be composed of a fully connected layer, a network module, a nonlinear activation function, and a normalization layer. To decrease the network computation amount and reduce the redundancy of information, the acoustic encoder in the initial model may further be added with a downsampling mechanism.
2. The audio features of the respective samples are input into the acoustic encoder in the initial model, and processed by the acoustic encoder in the initial model to obtain initial acoustic representation vectors of the respective samples. After the initial acoustic representation vectors are processed by the fully connected layer and the activation function, posterior probabilities of respective elements in the initial acoustic representation vectors of the respective samples can be obtained.

The elements in the initial acoustic representation vectors of the respective samples may be corresponding elements in the text vocabulary.

Exemplarily, the audio features of the respective samples are input into the acoustic encoder in the initial model and processed by the acoustic encoder in the initial model, and then the network outputs an acoustic representation vector in a certain dimension per M frames. The combinations of the acoustic representation vectors in the certain dimension output by the network per M frames are the initial acoustic representation vectors of the respective samples, where M is the downsampling rate.
3. Using the posterior probabilities of the respective elements in the initial acoustic representation vectors of the respective samples and the text data of the respective samples, the gradient information of all parameters in the acoustic encoder in the initial model is obtained using a cost function, and the parameters are updated using an optimizer.
4. Traversal is performed on the training data for a plurality of times. The above-mentioned steps 2-3 are repeated until the value of the cost function does not decrease obviously and the network converges.
Step 302-2: after the completion of training the acoustic encoder, obtaining the trained acoustic encoder, and training the acoustic encoder, the acoustic feature mapper, and the text feature extractor in the initial model using the trained acoustic encoder, initial acoustic representation vectors and text data, where the initial acoustic representation vectors and the text data are extracted from the respective samples.

In the embodiments of the present disclosure, the audio features of the respective samples are used as inputs into the trained acoustic encoder to obtain the initial acoustic representation vectors of the respective samples. With the initial acoustic representation vectors and the text data of the respective samples, the acoustic encoder, the acoustic feature mapper, and the text feature extractor in the initial model are trained simultaneously using the speech recognition related cost function and an audio-text feature alignment cost function. Specific steps are as follows.
1. The network parameters of the acoustic encoder trained in the above step 302-1 and the network parameters of the acoustic feature mapper in the initial model and the text feature extractor in the initial model are pre-loaded in the acoustic encoder in the initial model for random initialization. For example, the text feature extractor in the initial model may be composed of a multi-layer bilateral network, a fully connected layer, and a nonlinear activation function, and the acoustic feature mapper is composed of a fully connected layer, a network, a nonlinear activation function, and a normalization layer.
2. The audio features of the respective samples are input into the trained acoustic encoder to obtain the initial acoustic representation vectors of the respective samples, and the text data of the respective samples is input into the text feature extractor in the initial model to obtain text deep representation vectors of the respective samples. The length of the initial acoustic representation vector of a sample may be the number of frames Td after downsampling and the height is a corresponding vector dimension; and the length of the text deep representation vector of a sample is the number S of text vocabulary elements of the sample and the height is a corresponding vector dimension.

Optionally, training may be performed only on the text encoder of the text feature extractor in the initial model. Correspondingly, the text initial representation vectors of the respective samples are used as inputs into the text encoder to obtain text deep vectors of the respective samples.
3. The initial acoustic representation vectors of the respective samples are mapped, by the acoustic feature mapper in the initial model, to a feature space matched with the text deep representation vectors of the respective samples (i.e., aligned in vector dimension) to obtain target acoustic representation vectors of the respective samples. Point multiplication results of the target acoustic representation vectors of the respective samples and vectors corresponding to respective elements in the text deep representation vectors of the respective samples are determined, and an activation function is applied to the point multiplication results to obtain a similarity matrix of the target acoustic representation vectors of the respective samples and the text deep representation vectors of the respective samples, where the length and the width of the similarity matrix are the number S of text vocabulary elements of the respective samples and the number of frames Td after downsampling, respectively.

Matrix multiplication is performed on the similarity matrix and the text deep representation vectors of the respective samples. The length of the deep text representation vectors of the respective samples and the length of the target acoustic representation vectors of the respective samples are aligned to obtain the aligned text deep representation vectors of the respective samples. The target acoustic representation vectors of the respective samples and the aligned text deep representation vectors of the respective samples are input into the same fully connected layer and the activation function to obtain posterior probabilities of the target acoustic representation vectors of the respective samples and posterior probabilities of the aligned text deep representation vectors of the respective samples.

The posterior probabilities of the target acoustic representation vectors of the respective samples refer to probabilities of aligning the target acoustic representation vectors of the respective samples to the text data of the respective samples, and the posterior probabilities of the aligned text deep representation vectors of the respective samples refer to probabilities of aligning the aligned text deep representation vectors of the respective samples to the text data of the respective samples.

Exemplarily, in the case where the initial acoustic representation vectors of the respective samples are mapped, by the acoustic feature mapper, to the feature space matched with the text deep representation vectors of the respective samples, the mapping may also be frame-level mapping. That is, each frame vector in the initial acoustic representation vectors of the respective samples is mapped, by the acoustic feature mapper in the initial model, to the feature space matched with the corresponding text deep representation vectors of the respective samples to obtain the target acoustic representation vectors of the respective samples. Point multiplication results of the each frame vector in the target acoustic representation vectors of the each frame vector samples and the vectors corresponding to the respective elements in the text deep representation vectors of the respective samples are calculated, and the activation function is applied to the point multiplication results to obtain the similarity matrix of the target acoustic representation vectors of the respective samples and the text deep representation vectors of the respective samples.
4. The training cost function of the network is composed of 3 cost function parts added in a certain ratio. L_ctc1 is the cost function in the above-mentioned step 302-1; L_ctc2 is a cost function obtained from the posterior probabilities of the target acoustic representation vectors of the respective samples and the text data of the respective samples; and L_ctc3 is a cost function obtained from the posterior probabilities of the aligned text deep representation vectors of the respective samples and the text data of the respective samples. The final training cost function is L2=a1*L_ctc1+a2*L_ctc2+a3*L_ctc3, where a1, a2, and a3 are weights of the corresponding cost functions. For example, a1, a2, and a3 may be set based on requirements, e.g., a1=0.1 and a2=a3=1. The gradient information of all the parameters is calculated using L2, and the parameters are updated using the optimizer.
5. Traversal is performed on the training data for a plurality of times. The steps 2-4 are repeated until the value of the cost function L2 does not decrease obviously and the network converges.
Step 302-3: determining frame-level wake-up word labels of the respective samples in the positive and negative sample dataset.

In the embodiments of the present disclosure, the frame-level wake-up word label is a wake-up word label determined for each of a plurality of audio frames segmented from the audio data of the respective samples.

Exemplarily, in response to the audio frame including a wake-up word, the wake-up word label may be set to 1. In response to the audio frame including no wake-up word, the wake-up word label may be set to 0.

For a negative sample, because the audio data included in the negative sample has no wake-up word, for the audio data included in the negative sample, each frame of the audio data in the negative sample include no wake-up word. Therefore, the wake-up word existence label of each frame of the audio data in the negative sample may be set to 0.

For a positive sample, because the audio data included in the positive sample has one wake-up word, the wake-up word existence label of each frame of the audio data included in the positive sample may be set in the following way.

For example, the wake-up word existence label of each frame of the audio data included in the positive sample may be set based on whether the timestamp of the wake-up word is in a detection box. For example, the length of the detection box is h, e.g., 32 frames. For the audio data in the positive sample of the t-th frame, if the time period of the wake-up word is within a time period corresponding to [t−h, t], the label of the audio data in the positive sample of the t-th frame is set to 1. If the overlap of the time length corresponding to [t−h, t] and the time length of the wake-up word accounts for less than 70% of the total time length of the wake-up word, the label of the audio time of the t-th frame is set to 0, and the remaining frames do not participate in the calculation of the classification cost function.
Step 302-4: determining target acoustic representation vectors of the respective samples using a trained text feature extractor, a trained acoustic encoder, and a trained acoustic feature mapper; determining a wake-up word deep representation vector of each wake-up word using the trained text feature extractor; training the text feature extractor, the acoustic encoder, the acoustic feature mapper, and a decoder of the initial model using the target acoustic representation vectors of the respective sample, the wake-up word deep representation vector of the each wake-up word, and the frame-level wake-up word labels of the respective samples; and determining a trained initial model as the wake-up word detection model.

In the embodiments of the present disclosure, a training objective of the classification cost function is constructed with the audio features of the respective samples as inputs into the trained acoustic encoder and the wake-up words of the respective samples as inputs into the trained text feature extractor, and the text feature extractor, the acoustic encoder, the acoustic feature mapper, and the decoder of the initial model are trained simultaneously using the speech recognition related cost function, the audio-text feature alignment cost function, and a binary cost function. Specific steps are as follows.
1. The acoustic encoder, the text feature extractor and the acoustic feature mapper of the initial model are pre-loaded with the network parameters trained in step 302-2, and the network parameters of the decoder are randomly initialized. The decoder is composed of an attention mechanism module based on an activation function, a soft attention mechanism module, a network, a fully connected layer, and an activation function.
2. The target acoustic representation vectors of the respective samples are determined using the trained text feature extractor, the trained acoustic encoder, and the trained acoustic feature mapper. The wake-up words of the respective samples are input into the trained text feature extractor to obtain the wake-up word deep representation vectors of the respective samples. The target acoustic representation vectors of the respective samples and the wake-up word deep representation vectors of the respective samples are input into the attention mechanism module based on an activation function to obtain a first layer representation Z1 of the decoder. The vocabulary element dimension in Z1 is compressed, using the soft attention mechanism, to 1 dimension to obtain a second layer representation Z2 of the decoder. Z2 is input into the network and the fully connected layer to obtain a posterior probability that a wake-up word exists.

Exemplarily, partitioning and frame skipping operations may be performed on the target acoustic representation vectors of the respective samples to obtain partitioned target acoustic representation vectors. For example, each block includes 5 frames of data, and the number of frames skipped is 2. The partitioned target acoustic representation vectors have a total of Tc blocks of data. Correspondingly, the partitioned target acoustic representation vectors and the wake-up word deep representation vectors of the respective samples are input into the attention mechanism module based on an activation function to obtain the first layer representation of the decoder. The vocabulary element dimension in the first layer representation is compressed, using the soft attention mechanism, to 1 dimension to obtain the second layer representation of the decoder. The second layer representation is input into the network and the fully connected layer to obtain the posterior probability Po that a wake-up word exists. Po has a total of Tc frames.
3. The training cost function of the network is composed of 2 parts, where a first part is the training cost function in step 302-2, and a second part is a binary cross-entropy loss calculated from the posterior probability Po that a wake-up word exists obtained in step 2 and real wake-up word existence labels (i.e., the above-mentioned frame-level wake-up word labels of the respective samples). The final training cost function is L3=a1*L_ctc1+a2*L_ctc2+a3*L_ctc3+a4*L_bce, where a1, a2, a3, and a4 are weights of the corresponding cost functions. Specifically, a1, a2, and a3 may be set based on requirements, e.g., a1=0.1 and a2=a3=a4=1. The gradient information of all the parameters is calculated using L3, and the parameters are updated using the optimizer.
4. Traversal is performed on the training data for a plurality of times. The step 2 is repeated until the value of the cost function L3 does not decrease obviously and the network converges.

The acoustic encoder in the initial model in the embodiments of the present disclosure are subjected to training of three levels and the acoustic feature mapper and the text feature extractor in the initial model are subjected to training of two levels such that the trained text feature extractor, the trained acoustic encoder, and the trained acoustic feature mapper have high accuracy. In addition, the wake-up word detection model constructed based on the audio feature extractor, and the trained text feature extractor, acoustic encoder, acoustic feature mapper, and decoder in the initial model also has high accuracy.

In the embodiments of the present disclosure, the acoustic encoder in the initial model is subjected to training of three levels, and the acoustic feature mapper and the text feature extractor in the initial model are subjected to training of two levels. By these trainings, the wake-up word detection model constructed based on the trained text feature extractor, acoustic encoder, acoustic feature mapper, and decoder can achieve high accuracy of the wake-up word detection.

According to the wake-up word detection method provided by the embodiments of the present disclosure, the positive and negative sample dataset is constructed based on at least one wake-up word, and the stage-wise trained is performed on the initial model using the positive and negative sample dataset to obtain the wake-up word detection model. With the above technical solution, the wake-up word detection model can be determined by stage-wise training using the positive and negative sample dataset constructed based on the at least one wake-up word. The training of the wake-up word detection model can be achieved by relying on a general audio-text pair without collecting a large volume of audio data from different speakers for the wake-up word, and cold start training can be further supported, thereby reducing the data collection cost and the implementation difficulty and improving the efficiency of model training. Moreover, by end-to-end stage-wise training, the wake-up rate is increased, and the steps such as postprocessing and calibration are not needed, thereby simplifying the process and effectively improving the efficiency of the wake-up word detection.

FIG. 4 is a schematic structural diagram of a wake-up word detection apparatus provided by the embodiments of the present disclosure. The apparatus may be implemented by software and/or hardware, and may be generally integrated in an electronic device. As shown in FIG. 4, the apparatus includes:
an acquisition module 401 configured to acquire audio data and at least one wake-up word;
an outputting module 402 configured to input the audio data and the at least one wake-up word into a wake-up word detection model to output a frame-level detection probability of the audio data for the at least one wake-up word, where the wake-up word detection model is determined through stage-wise training using a positive and negative sample dataset constructed based on the at least one wake-up word;
and a determination module 403 configured to determine, based on the frame-level detection probability, a wake-up word detection result of the audio data for the at least one wake-up word.

In an optional embodiment, the wake-up word detection model includes an audio feature extractor, an acoustic encoder, an acoustic feature mapper, a text feature extractor, and a decoder; and the outputting module 402 includes:
a first determination sub-module configured to determine, by the text feature extractor in the wake-up word detection model, at least one wake-up word deep representation vector of the at least one wake-up word;
a second determination sub-module configured to determine, by the audio feature extractor, the acoustic encoder, and the acoustic feature mapper in the wake-up word detection model, a target acoustic representation vector of the audio data;
and a third determination sub-module configured to input the target acoustic representation vector and the at least one wake-up word deep representation vector into the decoder of the wake-up word detection model to determine a detection probability of each audio frame of the audio data for the at least one wake-up word, and combine a plurality of detection probabilities to obtain the frame-level detection probability.

In an optional embodiment, the text feature extractor includes a vocabulary feature extractor and a text encoder; and the first determination sub-module includes:
a fourth determination sub-module configured to determine, by the vocabulary feature extractor, at least one element mapped to a text vocabulary of each wake-up word, and determine a combination of at least one element vector of the at least one element as a wake-up word initial representation vector;
and a fifth determination sub-module configured to encode, by the text encoder, the wake-up word initial representation vector of each wake-up word to determine a corresponding wake-up word deep representation vector.

In an optional embodiment, the second determination sub-module includes:
an extraction sub-module configured to extract, by the audio feature extractor, an audio feature of the audio data;
a sixth determination sub-module configured to input the audio feature into the acoustic encoder to determine an initial acoustic representation vector;
and an alignment module configured to align, by the acoustic feature mapper, a feature space of the initial acoustic representation vector with a feature space of the wake-up word deep representation vector to obtain the target acoustic representation vector.

In an optional embodiment, the third determination sub-module includes:
a segmentation sub-module configured to segment the target acoustic representation vector by audio frame to obtain acoustic representation vectors of a plurality of audio frames;
and a detection sub-module configured to input the acoustic representation vectors of the audio frames and each wake-up word deep representation vector into the decoder to obtain the detection probability of each audio frame for each wake-up word.

In an optional embodiment, the determination module 403 includes:
a comparison sub-module configured to compare the detection probability of each audio frame in the frame-level detection probability with at least one wake-up word probability threshold corresponding to the at least one wake-up word;
and a seventh determination sub-module configured to, in response to the detection probability of a target audio frame being greater than the wake-up word probability threshold of a target wake-up word, determine that the target wake-up word is detected in the target audio frame in the audio data.

In an optional implementation, the apparatus further includes:
a construction module configured to construct the positive and negative sample dataset based on the at least one wake-up word;
and a training module configured to perform the stage-wise training on an initial model using the positive and negative sample dataset to obtain the wake-up word detection model.

In an optional embodiment, the positive and negative sample dataset includes a plurality of positive samples and a plurality of negative samples; each of the positive samples includes audio data with one wake-up word and text data thereof; and each of the negative samples includes audio data without the at least one wake-up word and text data thereof.

In an optional embodiment, the training module includes:
a first training sub-module configured to input the audio data of the respective samples in the positive and negative sample dataset into an audio feature extractor in the initial model to obtain audio features of the respective samples, and firstly train an acoustic encoder in the initial model using the audio features and text data of the respective samples;
a second training sub-module configured to train the acoustic encoder, an acoustic feature mapper, and a text feature extractor in the initial model using a trained acoustic encoder, and initial acoustic representation vectors and text data, where the initial acoustic representation vectors and the text data are extracted from the respective samples;
an eighth determination sub-module configured to determine frame-level wake-up word labels of the respective samples in the positive and negative sample dataset;
and a third training sub-module configured to determine target acoustic representation vectors of the respective samples using a trained text feature extractor, a trained acoustic encoder, and a trained acoustic feature mapper; determine a wake-up word deep representation vector of each wake-up word using the trained text feature extractor, train the text feature extractor, the acoustic encoder, the acoustic feature mapper, and a decoder of the initial model using the target acoustic representation vectors of the respective sample, the wake-up word deep representation vector of the each wake-up word, and the frame-level wake-up word labels of the respective samples; and determine a trained initial model as the wake-up word detection model.

The wake-up word detection apparatus provided by the embodiments of the present disclosure may perform the wake-up word detection apparatus method provided by any embodiment of the present disclosure and has corresponding functional modules for performing the method and corresponding beneficial effects.

The embodiments of the present disclosure further provide a computer program product, including a computer program/instructions which, when executed by a processor, implements/implement the wake-up word detection method provided by any embodiment of the present disclosure.

FIG. 5 is a schematic structural diagram of an electronic device provided by the embodiments of the present disclosure.

Referring to FIG. 5, FIG. 5 illustrates a schematic structural diagram of an electronic device 500 suitable for implementing the embodiments of the present disclosure. The electronic device 500 in the embodiments of the present disclosure may include but is not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and a fixed terminal such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected through a bus 504. An input/output (I/O) interface 505 is also connected to the bus 504.

Usually, the following apparatuses may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: acquire audio data and at least one wake-up word; input the audio data and the at least one wake-up word into a wake-up word detection model to output a frame-level detection probability of the audio data for the at least one wake-up word, where the wake-up word detection model includes an audio feature extractor, an acoustic encoder, an acoustic feature mapper, a text feature extractor, and a decoder, and the wake-up word detection model is determined through stage-wise training using a positive and negative sample dataset constructed based on the at least one wake-up word; and determine, based on the frame-level detection probability, a wake-up word detection result of the audio data for the at least one wake-up word.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It may be understood that before using the technical solutions disclosed in the embodiments of the present disclosure, it is necessary to inform user(s) the types, using scope, and using scenarios of personal information involved in the present disclosure according to relevant laws and regulations in an appropriate manner and obtain the authorization of the user(s).

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A wake-up word detection method, comprising:
acquiring audio data and at least one wake-up word;
inputting the audio data and the at least one wake-up word into a wake-up word detection model to output a frame-level detection probability of the audio data for the at least one wake-up word, wherein the wake-up word detection model is determined through stage-wise training using a positive and negative sample dataset constructed based on the at least one wake-up word; and
determining, based on the frame-level detection probability, a wake-up word detection result of the audio data for the at least one wake-up word.

2. The method according to claim 1, wherein the wake-up word detection model comprises an audio feature extractor, an acoustic encoder, an acoustic feature mapper, a text feature extractor, and a decoder; and the inputting the audio data and the at least one wake-up word into the wake-up word detection model to output the frame-level detection probability of the audio data for the at least one wake-up word comprises:
determining, by the text feature extractor in the wake-up word detection model, at least one wake-up word deep representation vector of the at least one wake-up word;
determining, by the audio feature extractor, the acoustic encoder, and the acoustic feature mapper in the wake-up word detection model, a target acoustic representation vector of the audio data; and
inputting the target acoustic representation vector and the at least one wake-up word deep representation vector into the decoder of the wake-up word detection model to determine a detection probability of each audio frame of the audio data for the at least one wake-up word, and combining a plurality of detection probabilities to obtain the frame-level detection probability.

3. The method according to claim 2, wherein the text feature extractor comprises a vocabulary feature extractor and a text encoder; and the determining, by the text feature extractor in the wake-up word detection model, at least one wake-up word deep representation vector of the at least one wake-up word comprises:
determining, by the vocabulary feature extractor, at least one element mapped to a text vocabulary of each wake-up word among the at least one wake-up word, and determining a combination of at least one element vector of the at least one element as a wake-up word initial representation vector; and
encoding, by the text encoder, the wake-up word initial representation vector of the each wake-up word to determine a corresponding wake-up word deep representation vector.

4. The method according to claim 2, wherein the determining, by the audio feature extractor, the acoustic encoder, and the acoustic feature mapper in the wake-up word detection model, a target acoustic representation vector of the audio data comprises:
extracting, by the audio feature extractor, an audio feature of the audio data;
inputting the audio feature into the acoustic encoder to determine an initial acoustic representation vector; and
aligning, by the acoustic feature mapper, a feature space of the initial acoustic representation vector with a feature space of the wake-up word deep representation vector to obtain the target acoustic representation vector.

5. The method according to claim 2, wherein the inputting the target acoustic representation vector and the at least one wake-up word deep representation vector into the decoder of the wake-up word detection model to determine the detection probability of each audio frame of the audio data for the at least one wake-up word comprises:
segmenting the target acoustic representation vector by audio frame to obtain acoustic representation vectors of a plurality of audio frames; and
inputting the acoustic representation vectors of the audio frames and each wake-up word deep representation vector into the decoder to obtain a detection probability of the each audio frame for each wake-up word.

6. The method according to claim 1, wherein the determining, based on the frame-level detection probability, the wake-up word detection result of the audio data for the at least one wake-up word comprises:
comparing a detection probability of each audio frame in the frame-level detection probability with at least one wake-up word probability threshold corresponding to the at least one wake-up word; and
in response to a detection probability of a target audio frame being greater than a wake-up word probability threshold of a target wake-up word, determining that the target wake-up word is detected in the target audio frame in the audio data.

7. The method according to claim 1, further comprising:
constructing the positive and negative sample dataset based on the at least one wake-up word; and
performing the stage-wise training on an initial model using the positive and negative sample dataset to obtain the wake-up word detection model.

8. The method according to claim 7, wherein the positive and negative sample dataset comprises a plurality of positive samples and a plurality of negative samples; each of the positive samples comprises audio data with one wake-up word and text data corresponding to the audio data with one wake-up word; and each of the negative samples comprises audio data without the at least one wake-up word and text data corresponding to the audio data without the at least one wake-up word.

9. The method according to claim 7, wherein the performing the stage-wise training on the initial model with the positive and negative sample dataset to obtain the wake-up word detection model comprises:
inputting audio data of respective samples in the positive and negative sample dataset into an audio feature extractor in the initial model to obtain audio features of the respective samples, and firstly training an acoustic encoder in the initial model using the audio features and text data of the respective samples;
training the acoustic encoder, an acoustic feature mapper, and a text feature extractor in the initial model using a trained acoustic encoder, and initial acoustic representation vectors and text data, wherein the initial acoustic representation vectors and the text data are extracted from the respective samples;
determining frame-level wake-up word labels of the respective samples in the positive and negative sample dataset; and
determining target acoustic representation vectors of the respective samples using a trained text feature extractor, a trained acoustic encoder, and a trained acoustic feature mapper; determining a wake-up word deep representation vector of each wake-up word among the at least one wake-up word using the trained text feature extractor; training the text feature extractor, the acoustic encoder, the acoustic feature mapper, and a decoder of the initial model using the target acoustic representation vectors of the respective sample, the wake-up word deep representation vector of the each wake-up word, and the frame-level wake-up word labels of the respective samples; and determining a trained initial model as the wake-up word detection model.

10. An electronic device, comprising:
a processor; and
a memory, configured to store instructions executable by the processor,
wherein the processor is configured to read the instructions from the memory and execute the instructions to implement a wake-up word detection method, and the wake-up word detection method comprises:
acquiring audio data and at least one wake-up word;
inputting the audio data and the at least one wake-up word into a wake-up word detection model to output a frame-level detection probability of the audio data for the at least one wake-up word, wherein the wake-up word detection model is determined through stage-wise training using a positive and negative sample dataset constructed based on the at least one wake-up word; and
determining, based on the frame-level detection probability, a wake-up word detection result of the audio data for the at least one wake-up word.

11. The electronic device according to claim 10, wherein the wake-up word detection model comprises an audio feature extractor, an acoustic encoder, an acoustic feature mapper, a text feature extractor, and a decoder; and the inputting the audio data and the at least one wake-up word into the wake-up word detection model to output the frame-level detection probability of the audio data for the at least one wake-up word comprises:
determining, by the text feature extractor in the wake-up word detection model, at least one wake-up word deep representation vector of the at least one wake-up word;
determining, by the audio feature extractor, the acoustic encoder, and the acoustic feature mapper in the wake-up word detection model, a target acoustic representation vector of the audio data; and
inputting the target acoustic representation vector and the at least one wake-up word deep representation vector into the decoder of the wake-up word detection model to determine a detection probability of each audio frame of the audio data for the at least one wake-up word, and combining a plurality of detection probabilities to obtain the frame-level detection probability.

12. The electronic device according to claim 11, wherein the text feature extractor comprises a vocabulary feature extractor and a text encoder, and the determining, by the text feature extractor in the wake-up word detection model, at least one wake-up word deep representation vector of the at least one wake-up word comprises:
determining, by the vocabulary feature extractor, at least one element mapped to a text vocabulary of each wake-up word among the at least one wake-up word, and determining a combination of at least one element vector of the at least one element as a wake-up word initial representation vector; and
encoding, by the text encoder, the wake-up word initial representation vector of the each wake-up word to determine a corresponding wake-up word deep representation vector.

13. The electronic device according to claim 11, wherein the determining, by the audio feature extractor, the acoustic encoder, and the acoustic feature mapper in the wake-up word detection model, a target acoustic representation vector of the audio data comprises:
extracting, by the audio feature extractor, an audio feature of the audio data;
inputting the audio feature into the acoustic encoder to determine an initial acoustic representation vector; and
aligning, by the acoustic feature mapper, a feature space of the initial acoustic representation vector with a feature space of the wake-up word deep representation vector to obtain the target acoustic representation vector.

14. The electronic device according to claim 11, wherein the inputting the target acoustic representation vector and the at least one wake-up word deep representation vector into the decoder of the wake-up word detection model to determine the detection probability of each audio frame of the audio data for the at least one wake-up word comprises:
segmenting the target acoustic representation vector by audio frame to obtain acoustic representation vectors of a plurality of audio frames; and
inputting the acoustic representation vectors of the audio frames and each wake-up word deep representation vector into the decoder to obtain a detection probability of the each audio frame for each wake-up word.

15. The electronic device according to claim 10, wherein the determining, based on the frame-level detection probability, the wake-up word detection result of the audio data for the at least one wake-up word comprises:
comparing a detection probability of each audio frame in the frame-level detection probability with at least one wake-up word probability threshold corresponding to the at least one wake-up word; and
in response to a detection probability of a target audio frame being greater than a wake-up word probability threshold of a target wake-up word, determining that the target wake-up word is detected in the target audio frame in the audio data.

16. The electronic device according to claim 10, wherein the wake-up word detection method further comprises:
constructing the positive and negative sample dataset based on the at least one wake-up word; and
performing the stage-wise training on an initial model using the positive and negative sample dataset to obtain the wake-up word detection model.

17. The electronic device according to claim 16, wherein the positive and negative sample dataset comprises a plurality of positive samples and a plurality of negative samples; each of the positive samples comprises audio data with one wake-up word and text data corresponding to the audio data with one wake-up word; and each of the negative samples comprises audio data without the at least one wake-up word and text data corresponding to the audio data without the at least one wake-up word.

18. The electronic device according to claim 16, wherein the performing the stage-wise training on the initial model with the positive and negative sample dataset to obtain the wake-up word detection model comprises:
inputting audio data of respective samples in the positive and negative sample dataset into an audio feature extractor in the initial model to obtain audio features of the respective samples, and firstly training an acoustic encoder in the initial model using the audio features and text data of the respective samples;
training the acoustic encoder, an acoustic feature mapper, and a text feature extractor in the initial model using a trained acoustic encoder, and initial acoustic representation vectors and text data, wherein the initial acoustic representation vectors and the text data are extracted from the respective samples;
determining frame-level wake-up word labels of the respective samples in the positive and negative sample dataset; and
determining target acoustic representation vectors of the respective samples using a trained text feature extractor, a trained acoustic encoder, and a trained acoustic feature mapper; determining a wake-up word deep representation vector of each wake-up word among the at least one wake-up word using the trained text feature extractor; training the text feature extractor, the acoustic encoder, the acoustic feature mapper, and a decoder of the initial model using the target acoustic representation vectors of the respective sample, the wake-up word deep representation vector of the each wake-up word, and the frame-level wake-up word labels of the respective samples; and determining a trained initial model as the wake-up word detection model.

19. A non-transitory computer-readable storage medium, storing a computer program, wherein the computer program is configured to perform a wake-up word detection method, and the wake-up word detection method comprises:
acquiring audio data and at least one wake-up word;
inputting the audio data and the at least one wake-up word into a wake-up word detection model to output a frame-level detection probability of the audio data for the at least one wake-up word, wherein the wake-up word detection model is determined through stage-wise training using a positive and negative sample dataset constructed based on the at least one wake-up word; and
determining, based on the frame-level detection probability, a wake-up word detection result of the audio data for the at least one wake-up word.

20. The storage medium according to claim 19, wherein the wake-up word detection model comprises an audio feature extractor, an acoustic encoder, an acoustic feature mapper, a text feature extractor, and a decoder, and the inputting the audio data and the at least one wake-up word into the wake-up word detection model to output the frame-level detection probability of the audio data for the at least one wake-up word comprises:
determining, by the text feature extractor in the wake-up word detection model, at least one wake-up word deep representation vector of the at least one wake-up word;
determining, by the audio feature extractor, the acoustic encoder, and the acoustic feature mapper in the wake-up word detection model, a target acoustic representation vector of the audio data; and
inputting the target acoustic representation vector and the at least one wake-up word deep representation vector into the decoder of the wake-up word detection model to determine a detection probability of each audio frame of the audio data for the at least one wake-up word, and combining a plurality of detection probabilities to obtain the frame-level detection probability.
